(19) United States
(12) Patent Application Publication
(10) Pub. No.: US 2026/0072781 A1
(43) Pub. Date: Mar. 12, 2026

(54) METHODS, SYSTEMS AND DEVICES TO DETERMINE OPERATIONAL DEVIATIONS AND IMPLEMENT REMEDIATION ACTIONS OF SOFTWARE APPLICATION(S) IMPLEMENTED IN A CLOUD SOLUTION ENVIRONMENT

(71) Applicant: JPMorgan Chase Bank, N.A., New York, NY (US)

(72) Inventors: Tendai Chinoda, Cranberry Township, PA (US); Rajneesh Mehta, Waxhaw, NC (US); Rajesh Nakkana, Irving, TX (US); Abhijeet Talele, Aubrey, TX (US)

(73) Assignee: JPMorgan Chase Bank, N.A., New York, NY (US)

(21) Appl. No.: 19/324,720

(22) Filed: Sep. 10, 2025

Related U.S. Application Data
(60) Provisional application No. 63/693,590, filed on Sep. 11, 2024.

(51) Int. Cl. G06F 11/07; G06F 8/10; G06F 8/35; G06F 11/30

(52) U.S. Cl. CPC G06F 11/0793; G06F 8/10; G06F 8/35; G06F 11/302

(57) ABSTRACT

Aspects of the subject disclosure may include, for example, obtaining a group of software application design requirements associated with a software application, generating an intended operational state of the software application based on the group of software application design requirements, and building the software application utilizing one of more cloud computing resources based on the group of software application design requirements. Further embodiments include obtaining actual operational state data associated with the building of the software application from a group of data stores, determining an actual operational state of the software application based on the actual operational state data, and identifying a group of deviations from the intended operational state and the actual operation state. Additional embodiments include determining a group of remediation actions associated with the group of deviations, and implementing a first portion of the group of remediation actions on the software application. Other embodiments are disclosed.

### CROSS REFERENCE TO RELATED APPLICATIONS

This application claims priority to U.S. Provisional Patent Application Ser. No. 63/693,590 filed on Sep. 11, 2024. All sections of the aforementioned application are incorporated herein by reference in their entirety.

### FIELD OF THE DISCLOSURE

The subject disclosure relates to methods, systems, and devices to determine operational deviations and implement remediation actions of software application(s) in a cloud solution environment.

### BACKGROUND

In the current state of the art, there is a disconnect between the operational stage, and the design stage as well as the build stage of developing software application(s) utilizing the cloud solution lifecycle (e.g., software application). The actual operational state, or runtime behavior, of a cloud solution (e.g., software application) may deviate from its intended operational state, as defined by the cloud solution owner and outlined in the solution design. Throughout the various stages of cloud lifecycle, including Cloud Day 0 (Design), Day 1 (Build) and Day 2 (Operate), numerous data sources can be generated that can help remediate any deviations. However, these data sources remain underutilized and siloed.

### SUMMARY OF THE DISCLOSURE

The subject disclosure describes, among other things, illustrative embodiments for obtaining a group of software application design requirements associated with a software application, generating an intended operational state of the software application based on the group of software application design requirements, and building the software application utilizing one of more cloud computing resources based on the group of software application design requirements. In some embodiments, a graphical representation of the intended operational state to store as a knowledge graph in a graph database. Gaps can also be detected between the intended operational state and the solution intent. Further embodiments may include obtaining actual operational state data associated with the building of the software application from a group of data stores, determining an actual operational state of the software application based on the actual operational state data, and identifying a group of deviations from the intended operational state and the actual operation state. Additional embodiments may include determining a group of remediation actions associated with the group of deviations, and implementing a first portion of the group of remediation actions on the software application. Other embodiments are described in the subject disclosure.

One or more aspects of the subject disclosure include a device, comprising a processing system including a processor, and a memory that stores executable instructions that, when executed by the processing system, facilitate performance of operations. The operations may comprise obtaining a group of software application design requirements associated with a software application, generating an intended operational state of the software application based on the group of software application design requirements, and building the software application that is intended utilizing one of more cloud computing resources based on the group of software application design requirements. Further operations may comprise obtaining actual operational state data associated with the building of the software application from a group of data stores, determining an actual operational state of the software application based on the actual operational state data, and identifying a group of deviations from the intended operational state and the actual operation state. Additional operations may comprise determining a group of remediation actions associated with the group of deviations, and implementing a first portion of the group of remediation actions on the software application.

One or more aspects of the subject disclosure include a non-transitory machine-readable medium, comprising executable instructions that, when executed by a processing system including a processor, facilitate performance of operations. The operations may comprise obtaining a group of software application design requirements associated with a software application, generating an intended operational state of the software application based on the group of software application design requirements, and building the software application utilizing one or more cloud computing resources based on the group of software application design requirements. Further operations may comprise, after the actual operational state is built and stored in a data store, obtaining actual operational state data associated with the building of the software application from a group of data stores, determining an actual operational state of the software application based on the actual operational state data, and identifying a group of deviations from the intended operational state and the actual operation state utilizing a group of large language models. Additional operations may comprise determining a group of remediation actions associated with the group of deviations utilizing the group of large language models, and implementing a first portion of the group of remediation actions on the software application.

One or more aspects of the subject disclosure include a method. The method may comprise obtaining, by a processing system including a processor, a group of software application design requirements associated with a software application, generating, by the processing system, an intended operational state of the software application based on the group of software application design requirements, and building, by the processing system, the software application utilizing one of more cloud computing resources based on the group of software application design requirements. Further, the method may comprise obtaining, by the processing system, actual operational state data associated with the building of the software application from a group of data stores, determining, by the processing system, an actual operational state of the software application based on the actual operational state data, and identifying, by the processing system, a group of deviations from the intended operational state and the actual operation state. In addition, the method may comprise determining, by the processing system, a group of remediation actions associated with the group of deviations, and implementing, by the processing system, a first portion of the group of remediation actions on the software application. Also, the method may include receiving, by the processing system, over a communication network, user-generated input, wherein the user-generated input indicates to implement a second portion of the group of remediation actions, and implementing, by the processing system, the second portion of the group of remediation actions on the software application.

### BRIEF DESCRIPTION OF THE DRAWINGS

Reference will now be made to the accompanying drawings, which are not necessarily drawn to scale, and wherein:

FIGS. 1, 2A, and 2B are block diagrams illustrating exemplary, non-limiting embodiments of a system for determining operational deviations and implementing remediation actions of a software application developed in a cloud environment in accordance with various aspects described herein.

FIG. 2C-1 and FIG. 2C-2 depict an illustrative embodiment of a method in accordance with various aspects described herein.

FIG. 2D is a block diagram illustrating exemplary, non-limiting embodiment of a system for determining operational deviations and implementing remediation actions of a software application developed in a cloud environment in accordance with various aspects described herein.

FIG. 2E is an exemplary user interface interacting with an exemplary, non-limiting embodiment of a system for determining operational deviations and implementing remediation actions of a software application developed in a cloud environment in accordance with various aspects described herein.

FIG. 3 depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

One or more embodiments may include software application(s) that are developed in a cloud environment and may implement a solution for an enterprise such as determining investment strategies for a wealth manager or a payment platform for businesses and their customers. Further, the solution/software application design requirements may be drafted to implement an intended operational state of the solution/software application. The solution/software application may be built based on the drafted design requirements. Then the built solution/software application may be placed into operation accordingly. In some embodiments, the actual operational state of the solution/software application may include one or more deviations from the intended operational state determined from solution/software application design requirements. Further embodiments, provide a method to effectively leverage data sources to identify deviations between the intended operational state and the actual operational state of a solution/software, and to deliver recommendations to remediate the deviation Additional embodiments identify these deviations and determine remediation actions to correct them utilizing various machine learning (ML) and/or artificial intelligence (AI) including large language models (LLMs).

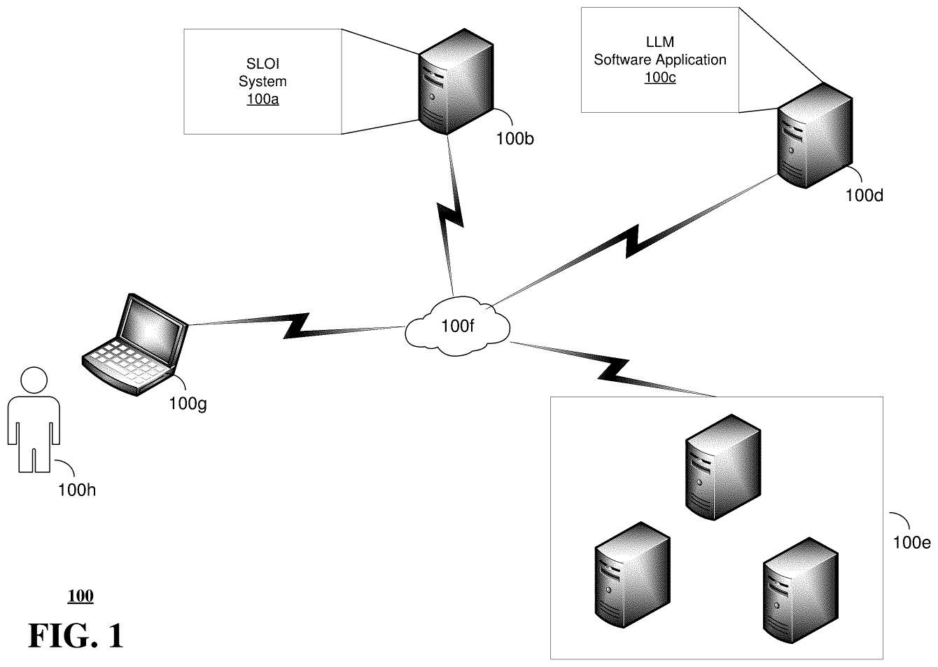

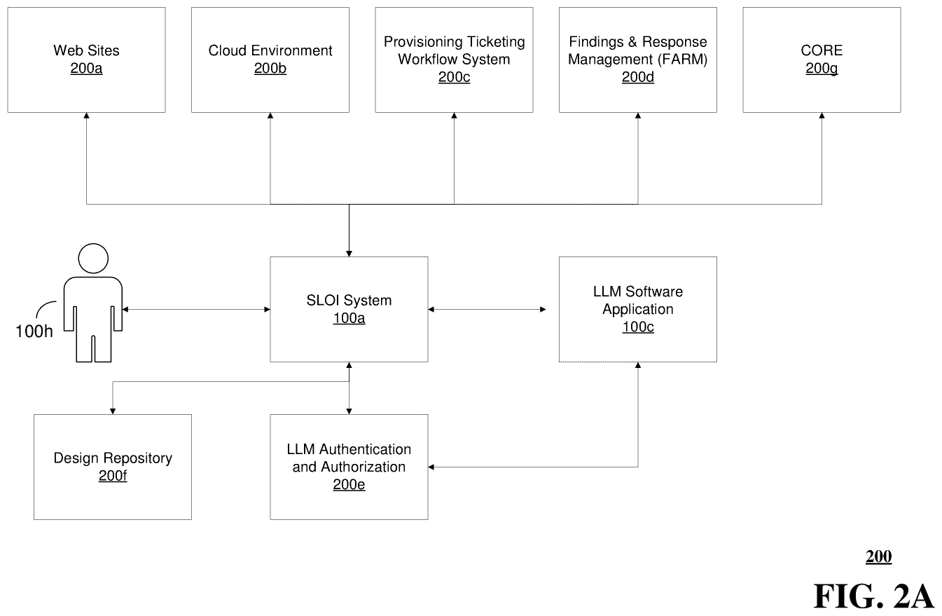

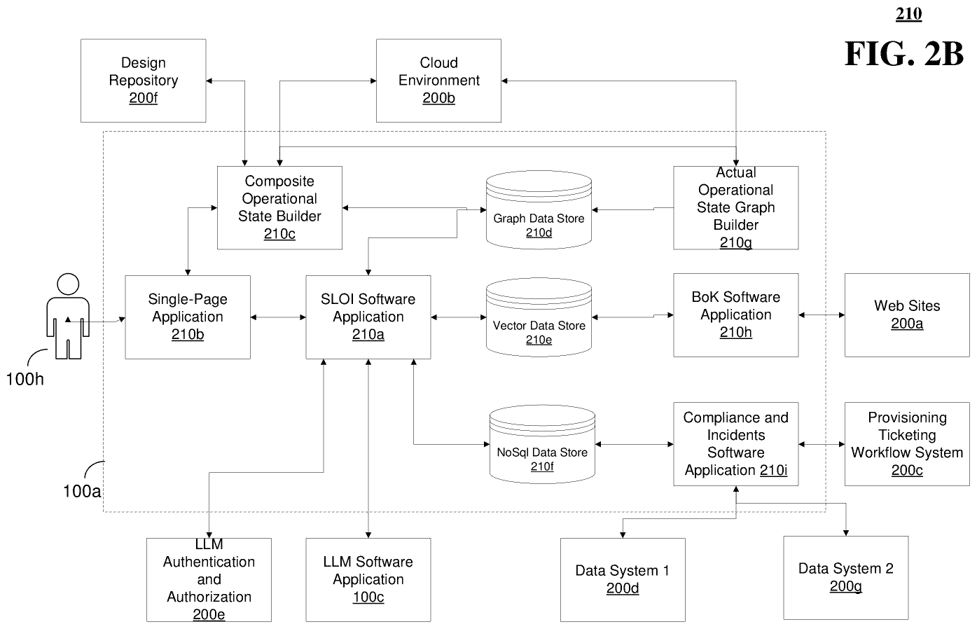

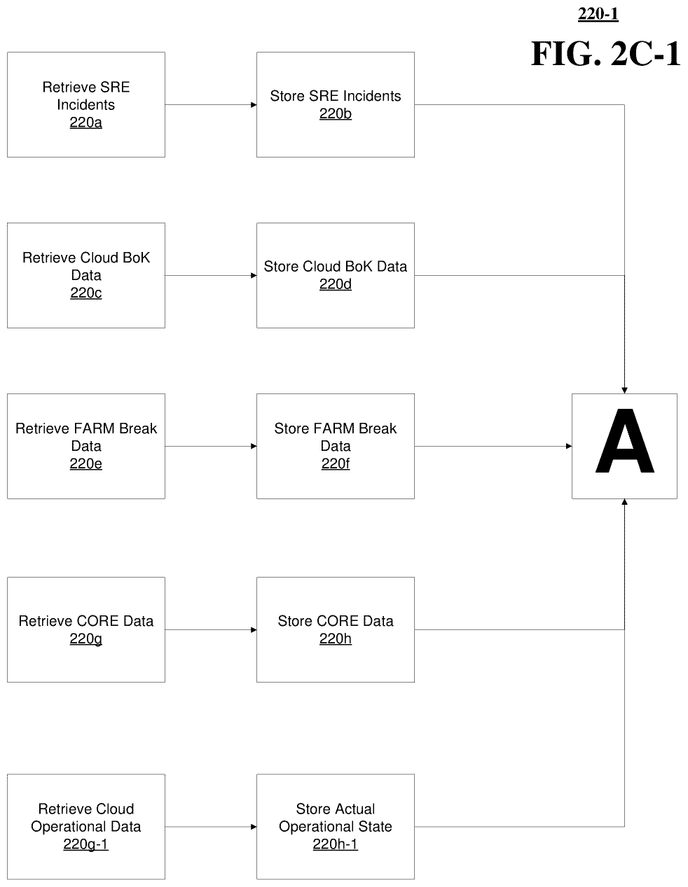

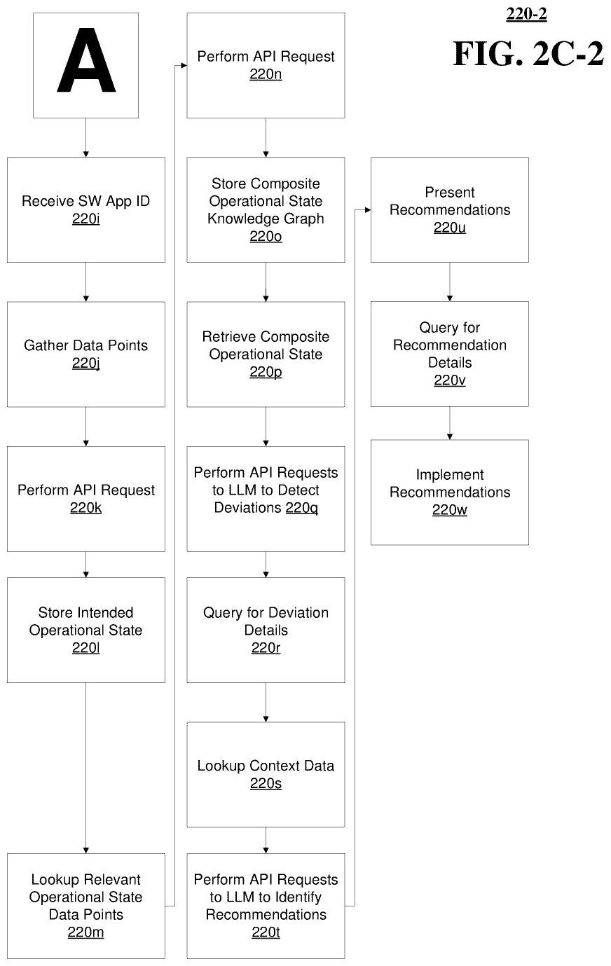

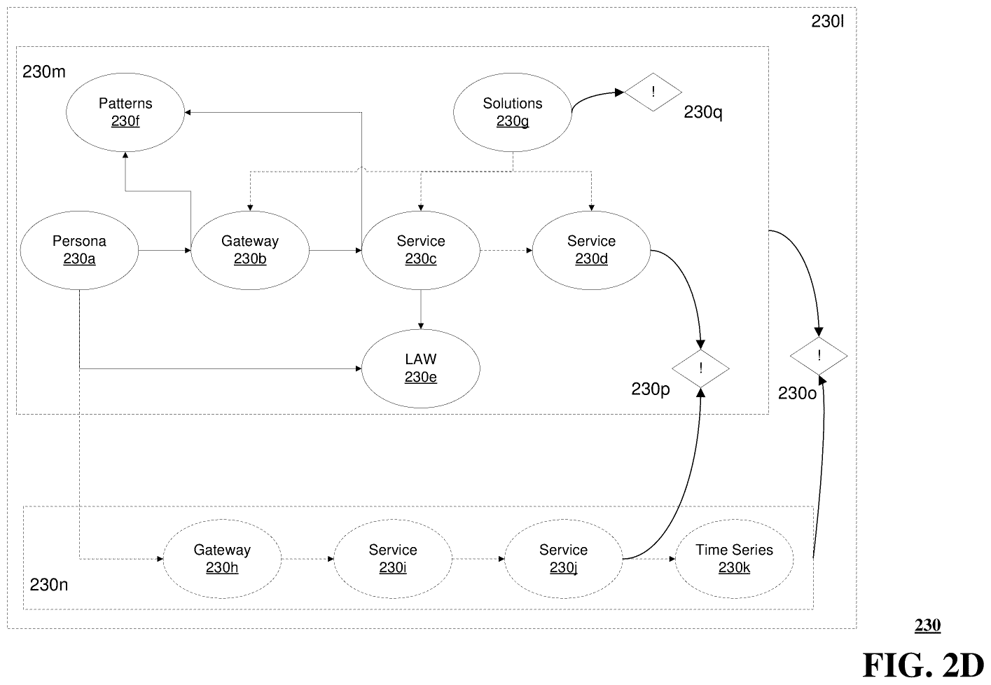

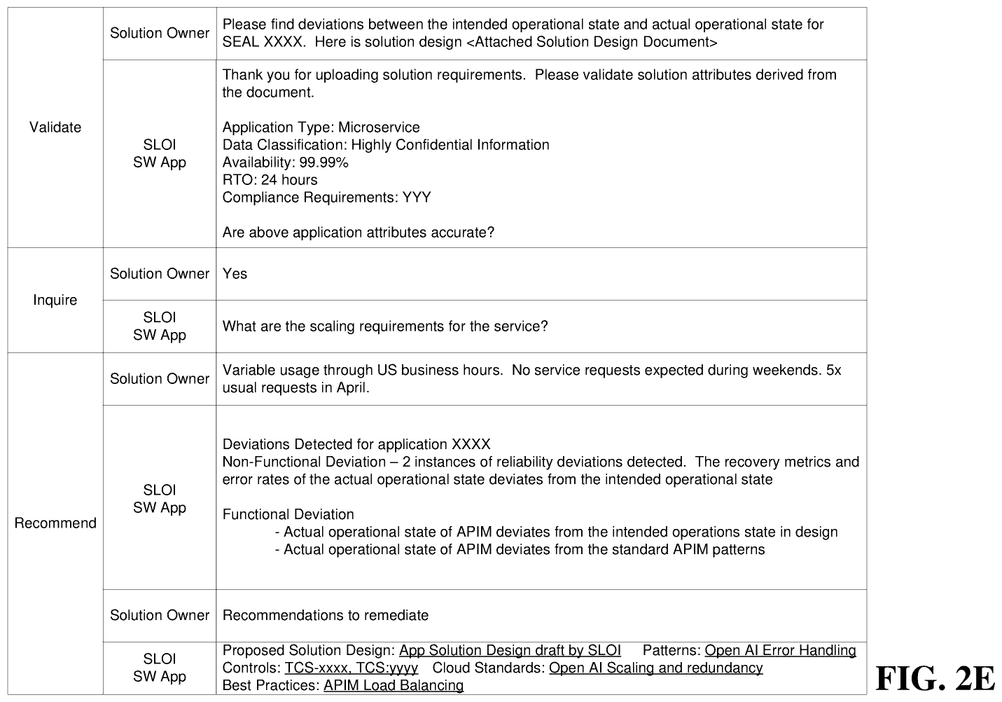

FIGS. 1, 2A, and 2B are block diagrams illustrating exemplary, non-limiting embodiments of a system for determining operational deviations and implementing remediation actions of a software application developed in a cloud environment in accordance with various aspects described herein.

Referring to FIG. 1, in one or more embodiments, system 100 may include a shift left operational insight (SLOI) system 100a implemented on a server 100b, a LLM software application 100c implemented on a server 100d, a group of servers 100e on which the software (e.g., solution) that is currently subject of the SLOI system 100a is implemented, and a communication device 100g associated with user 100h, all of which are communicatively coupled with each other over communication network 100f. Each of server 100b, server 100d, and group of servers 100e may represent one or more servers residing in one location or spanning multiple locations, one or more virtual servers residing in one location or spanning multiple locations, one or more cloud servers, or a combination thereof. Further, communication device 100g may include, but is not limited to, a laptop computer, desktop computer, mobile device, mobile phone, smartphone, tablet computer, or any other communication device. In addition, communication network 100f may comprise one or more wireless communication networks, one or more wired communication networks, or a combination thereof.

In one or more embodiments, the cloud solution lifecycle comprises a design stage, a build stage, and an operations stage. The “shift left” term in the SLOI system 100a refers to the SLOI system 100a gaining operational insight from the actual operational state in the operations stage and comparing it the intended operational state from the design stage, which is a “shift left” in the cloud solution lifecycle. This operational insight may include identifying deviations of the actual operational state from the intended operational state and determining remediation actions for these deviations utilizing the LLM software application 100c. Although embodiments described herein are directed to the SLOI system 100a analyzing a solution/software application, specifically in analyzing software application(s) associated with the solution, persons of ordinary skill in the art would understand that a solution and software application(s) analyzed by the SLOI system 100a are interchangeable or the same. Additionally, while embodiments described herein utilize LLM techniques, other types of ML and/or AI, including other types of models, may also be implemented in conjunction with, or in place of, the LLM techniques.

Referring to FIG. 2A, in one or embodiments, system 200 may include a user 100h interacting with the SLOI system 100a (via communication device 100g). Further, the SLOI system 100a may interact with several other systems, software applications, and databases associated with the solution/software application(s) that is subject to analysis by the SLOI system 100a. These may include web sites 200a, cloud environment 200b, provisioning ticketing workflow system 200c, Findings and Response Management (FARM) system 200d, and Compliance & Operational Risk Evaluation (CORE) system 200g. Web sites 200a may include a web server that hosts internal confluence pages and external web pages containing information such as reference architecture, patterns, which will be used to resolve remediation. For example, if the solution/software application is directed to a payment platform to a business to receive payments from customers, the web server may host a web site that allows customers to render payment to the business. The cloud environment 200b may include the computing resources (e.g., processing capacity, memory capacity, etc.), which are used to obtain logs and metrics so that the actual operational state of the software application can be determined. The provisioning ticketing workflow system may implement site reliability engineering associated with the solution/software application that may include tracking adherence to service-level agreements, change management, monitoring performance metrics, planning capacity for future growth, etc. Incident data can be collected from the provisioning ticketing workflow system. The Findings & Response Management (FARM) system 200d can include data containing findings of breaks, violations, and non-compliance items for the applications associated to a SEAL. The Compliance & Operational Risk Evaluation (CORE) system 200g may include data containing process, risk, controls and issues data. LOBs and functions can maintain CORE system 200g, the processes that reflect activities they perform and the for which they are accountable. Each process can identify risks associated to their processes and assess their impact. Controls operate to mitigate risks through preventative, detective, and directive type controls. Compliance and operational risk issues can be identified. The system 200 may also include a design repository 200f that may be a database storing the design requirements for the solution/software application. Further, the system 200 may include LLM software application 100c, which may be used by the SLOI system to identify deviations from the intended operational state and the actual operational state, as well as determine remedial actions for the deviations for the solution/software application. The LLM software application can utilize one or more LLM, AI, and/or ML models to determine deviations and/or remedial actions. The LLM authentication and Authorization system 200e is used by the SLOI system 100a to gain access to the LLM software application 100c.

Referring to FIG. 2B, in one or more embodiments, system 210 includes aspects of system 200 but includes details of the components of the SLOI system 100a. Specifically, system 210 includes web sites 200a, cloud environment 200b, provisioning ticketing workflow system 200c, FARM system 200d, CORE system 200g, design repository 200f, LLM software application 100c, and LLM authentication and authorization system 200e, which are components of system 200.

In one or more embodiments, the SLOI system 100a may include the SLOI software application 210a, the single-page application 210b (e.g., any form of interactive user interface) user interface to be interacted by user 100h via a web browser on communication device 100g), composite operational state builder 210c, graph data store 210d, vector data store 210e, NoSQL data store 210f, actual operational state graph builder 210g, Book of Knowledge (BoK) software application 210h, and compliance and incidents software application 210i. Some of the functions of the components the SLOI system 100a and their interaction with the other components of system 200/system 210 may be described in conjunction with describing the steps of method 220 in FIG. 2C-1 and FIG. 2C-2.

Referring to FIG. 2C-1, in one or more embodiments, the method 220 may be implemented by aspects of system 210. Step 220a and step 220b of method 220 are directed to retrieving site reliability engineering (SRE) data. Method 220 may include the compliance and incidents software application 210i, at step 220a, retrieving data associated with SRE incidents from the provisioning ticketing workflow system 200c. The SRE incident data may be related to solution/software application issues such as errors, downtimes, and degraded performance. Further, method 220 may include the compliance and incidents software application 210i, at step 220b, storing the SRE incident data into the NoSQL data store 210f. Prior to storing the SRE incident data, the compliance and incidents software application 210i may process the SRE incident data by transforming and enhancing it (e.g., with metadata) for storing into the NoSQL data store 210f.

In one or more embodiments, step 220c and step 220d of method 220 may be directed to retrieving cloud BoK data and storing cloud BoK data. Specifically, the method 220 may include the BoK software application 210h, at step 220c, retrieving cloud BoK data, which can include retrieving internal and external data from confluence pages and external web sites 200a. The internal and external data may include reference architectures, architecture patterns, cloud guidelines and principles, etc. Further, the method 220 may include the BoK software application 210h, at step 220d, storing cloud BoK data, which can include cleaning the retrieved data, partitioning it into smaller parts, creating embeddings to convert them into numerical vectors, enhancing them with metadata, and storing them in the vector data store 210e.

In one or more embodiments, step 220e and step 220f may be directed to retrieving FARM breaks data. Method 220 may include the compliance and incidents software application 210i, at step 220e, retrieving FARM breaks data from the FARM system 200d. Further, method 220 may include the compliance and incidents software application 210i, at step 220f, storing the FARM breaks data into the NoSQL data store 210f. Prior to storing, the compliance and incidents software application 210i may transform the FARM breaks data to adhere to a format associated or compatible with the NoSQL data store 210f.

In one or more embodiments, step 220g and step 220h may be directed to retrieving and storing CORE data. Method 220 may include the compliance and incidents software application 210i, at step 220g, retrieving CORE data from the CORE system 200g. Further, the method 220 may include the compliance and incidents software application 210i, at step 220h, storing the CORE data into the NoSQL data store 210f. Prior to storing, the compliance and incidents software application 210i may transform the CORE data to adhere to a format associated or compatible with the NoSQL data store 210f.

In one or more embodiments, step 220g-1 and step 220h-1, are directed to generating the actual operational state of the solution/software application. Method 220 may include the composite operational state builder 210c, at step 220m, retrieving data from the cloud environment 200b pertaining to implementation of the solution/software application and generate the actual operational state, which may be represented by a knowledge graph. In some embodiments, based on the cloud environment data, the composite operational state builder 210c may correlate the actual operational state's functional aspects to the intended operational state's functional attributes, prior to generating the actual operational state graph. Further, method 220 may include the composite operational state builder 210c, at 220n, storing the actual operational state graph in the graph data store 210d. Prior to storing, the composite operational state builder 210c may validate the actual operational state graph using evaluation methods for correctness, reliability, and accuracy. Such an evaluation of the actual operational state may be associated with a score. If the score associated with intended operational state is above a threshold, then it may be stored in the graph data store 210d.

Referring to FIG. 2C-2, in one or more embodiments, method 220 can be implemented by aspects of an SLOI system. Method 220 can include the SLOI system, at 220i, receiving a software application identifier. Further, the method 220 can include the SLOI system, at 220j, gathering data points for creating an intended operations state for the cloud software application. This can further include collecting and interpreting a solution design diagram and performing human inquiry to validate and gather additional inputs to fully create a qualified intended operational state. In addition, the method 220 can include the SLOI system, at 220k, performing API request to LLM to convert data points gathered to a knowledge graph representation of intended operational state. Also, the method 220 can include the SLOI system, at 220l, storing intended operational state in a knowledge graph of a graph database.

In one or more embodiments, the method 220 can include the SLOI system, at 220m, looking up relevant operational state data points for the software application identifier. Further, the method 220 can include the SLOI system, at 220n, performing API request to LLM to convert data points to create a composite state. In addition, the method 220 can include the SLOI system, at 220o, storing composite operational state knowledge graph in graph database. Also, the method 220 can include the SLOI system, at 220p, retrieving composite operational state according to software application identifier. Further, the method 220 can include the SLOI system, at 220q, perform API requests to LLM to detect deviations between intended operational state and actual operational state. In addition, the method 220 can include the SLOI system, at 220r, querying or drilling down to query about details of the deviations such as reviewing logs, metrics, or SRE incidents. Also, the method 220 can include the SLOI system, at 220s, looking up context data. Further, the method 220 can include the SLOI system, at 220t, performing API requests to LLM to identify recommendations to resolve deviations. In addition, the method 220 can include the SLOI system, at 220u, presenting architecture and engineering recommendations to remediate the deviation(s). Also, the method 220 can include the SLOI system, at 220v, querying recommendation for details, which can include asking specific questions. Further, the method 220 can include the SLOI system, at 220w, implementing recommended remedial actions.

In one or more embodiments, the SLOI system 100a may employ a multi-agent framework, retrieval augmented generation (RAG), and knowledge graphs. The multi-agent framework facilitates multi-faceted problem solving required by the SLOI system 100a. This includes recognizing operational states for cloud solutions, detecting deviations, and providing architectural and engineering remediation action recommendations as well as implementing a portion of the remediation actions based on user-generated input and implementing another portion of the remediation actions automatically without any human intervention. Further, the multi-agent framework enables communication among agents within the SLOI system 100a, each contributing their respective expertise. Through this collaboration, these agents may address complex challenges more efficiently than a single LLM model alone. In some embodiments, the multi-agent framework may include a deviation detection agent, a compliance and incidents agent, a cloud BoK recommendation agent, an operations recommendation agent, a solution intent gap detection agent, an intended operational state derivation agent, and a user proxy agent. The deviation detection agent identifies deviations between the intended operational state and the actual operational state of a solution/software application. The compliance and incidents agent queries incidents and compliance data from FARM, CORE, and the provisioning ticketing workflow system.

The cloud BoK recommendation agent provides recommendations to remediate the deviations derived from the cloud body of knowledge. The operations recommendation agent provides recommendations to remediate the deviations derived from high-performing workloads. The solution intent gap detection agent identifies gaps in the user provide solution intent to create a comprehensive intended operational state. The intended operational state derivation agent generates the intended operational state from the user submitted solution intent (e.g., design requirements). The user proxy agent may be a proxy agent for a user to solicit user-generated input as the agent's reply at each interaction turn by default and also having the capability to execute code and call functions or tools.

In one or more embodiments, the SLOI system 100a employs a RAG to augment context LLM software application 100c with relevant data stored in enterprise data stores. For example, the cloud BoK recommendation agent may retrieve relevant data from the vector data store that comprises the enterprise cloud body of knowledge that may include reference architectures, standards, patterns, guidelines, etc.

In one or more embodiments, the SLOI system 100a leverages knowledge graph data structures to depict the intended operational state and actual operational state of a solution/software application. An advantage of knowledge graphs lies in their capacity to present knowledge as a network comprising entities and relationships. When used with RAG, it enables deep and complex relationship analysis by providing the ability to navigate these relationships through multiple hops and identify deviations between the intended operational state and the actual operational state accordingly.

In one or more embodiments, one or more LLM models can be selected. Further selection of one or more LLM models can be based on the available compute resources supporting the LLM model(s). In some embodiments, there may be a compute resources availability threshold. If the compute resources satisfy the compute resources availability threshold, then one LLM model can be selected. However, the compute resources does not satisfy the compute resources availability threshold, then another LLM model can be selected. Moreover, the LLM models can be utilized by a LLM software application described herein and can identify remediation actions to adjust the software application to perform from an actual operational state to the intended operational state.

Referring to FIG. 2D, in one or more embodiments, system 230 shows the identifying of deviations from actual operational state graph from an intended operational state graph. Further, system 230 includes a composite graph 230l that includes an intended operational state graph 230m and an actual operating state graph 230n. The intended operational state graph includes a persona node 230a, a gateway node 230b, a service node 230c, and a service node 230d. Further, the actual operational state graph 230m may include a gateway node 230h, a service node 230i, service node 230j, and a time series node 230k.

In one or more embodiments, each node may be associated with functional aspects and non-functional aspects (e.g., attributes). The persona node 230a may be functionally associated with a user and an attribute may be a type of user (e.g., data scientist). The gateway node 230b may be associated with functional aspects that include a service, type of gateway, identifier, and release, as well as attributes that include the type of gateway application. Both service node 230c and service node 230d may be associated with functional aspects that include the type of service, service identifier and release as well as attributes that include the name of the service and any metrics associated with the respective service. The pattern node 230f may be associated with functional aspects that include the patterns included in the node as well as any attributes. The solution node 230g may be associated with functional aspects that include the identifier of the cloud environment implementing the solution/software application and the release as well as attributes such as the availability of the cloud environment (e.g., 99.99%). The Log Analytics Workspace (LAW) node 230e (which monitors other nodes) may be associated with functional aspects that include its service, identifier, and release (e.g., it may not have any attributes). Further, the LAW node 230e may be used to collect logs and metrics from cloud services that are part of a monitored cloud workload.

In one or more embodiments, the gateway node 230h may be associated with functional aspects that include its service (e.g., gateway), identifier, and release, as well as its attributes that include its name. Both service node 230i and service node 230j may be associated with functional aspects that include its service, identifier, and release, as well as its attributes that may include its name. Time Series node 230k may include attributes that are metrics associated with the actual operational state.

In one or more embodiments, traversing the intended operational state graph 230m, the persona node 230a may invoke the gateway node 230b. Further, gateway node 230b may pass a token or perform an API request of service node 230c. In addition, service node 230c may pass a token or perform an API request of service node 230d. Also, the gateway node 230b and the service node 230c may be tagged by the patterns node 230f for recommendation for remediation actions. Further, the gateway node 230b, service node 230c, and service node 230d are represented by the solutions node 230g. That is, the gateway node 230b, service node 230c, and service node 230d are instantiated in a cloud environment implementing the solution/software application. In addition, the persona node 230a invokes monitoring the system utilizing the LAW node 230e. Also, the LAW node 230e may retrieve logs from service node 230c.

In one or more embodiments, traversing the actual operational state graph 230n, the persona node 230a may invoke the gateway node 230h. Further, gateway node 230h may pass a token or perform an API request of service node 230i. In addition, service node 230i may pass a token or perform an API request of service node 230j. Also, the time series node 230k may aggregate metrics from service node 230j.

In one or more embodiments, the SLOI software application 210a may utilize LLM software application 100c to identify deviations from the intended operational state graph 230m and the actual operational state graph 230n that may include deviation 230o and deviation 230p. Deviation 230o is identified as a functional deviation because a service is identified as missing from the actual operational state graph 230n but is identified as included in the intended operational state graph 230m. Deviation 230p is identified as a non-functional deviation that indicates the observed number of errors in the actual operational state graph 230n is greater than a threshold included in the intended operational state graph 230m. Deviations 230q aggregates deviation 230o and deviation 230p and associates them with the solution node 230g. In some embodiments, if a non-functional deviation such as an indication of a number of observed number of errors (e.g., packet loss in data transmission, mistakes in rendering payment, mistakes in allocating investments, etc.) is above a first threshold but below a second threshold (the second threshold is above the first threshold), a remediation action (generated by the LLM software application 100c) to mitigate the non-functional deviation can be automatically implemented without human intervention. However, if the number of observed errors is above the second threshold, the LLM software application 100c can generate a recommended remediation action to provide to a user, who then provides user-generated input indicating to implement the remediation action, and the system implements the remediation actions (e.g., provide more compute resources to mitigate packet loss, provide more network bandwidth to mitigate packet loss, adjust the payment processing algorithms to mitigate payment mistake, adjust investment allocation algorithms to mitigate investment allocation mistakes, etc.), to mitigate the non-functional deviation, accordingly.

FIG. 2E is an exemplary user interface 240 interacting with an exemplary, non-limiting embodiment of a system for determining operational deviations and implementing remediation actions in accordance with various aspects described herein. The interaction between the SLOI system via the user interface 240 (e.g., instantiated in the single-page application 210b) and the user 100h may include a validation phase, an inquiry phase, and a recommendation phase.

In one or more embodiments, the validation phase may include the solution owner (e.g., user) requesting the SLOI system to find deviations between the intended operational state and the actual operational state for a particular solution/software application given by its identifier. Further, the solution owner may upload the solution/software application design requirements. Subsequently, the SLOI software application may request to validate the solution/software application attributes. During the inquiry phase, the solution owner may respond to the validation request by the SLOI software application. Further, the SLOI software application may inquire about the scaling requirements for the service associated with the solution/software application. During the recommendation phase, the solution owner may respond to the inquiry from the SLOI software application regarding scaling requirements. Further, the SLOI software application may list the deviations detected between the intended operational state and the actual operational state. In addition, the solution owner may request recommendations to remediate the deviations. Also, the SLOI software application may list the recommended remediation actions as links, accordingly. The solution owner may click any of the remediation action links to implement the respective remediation action.

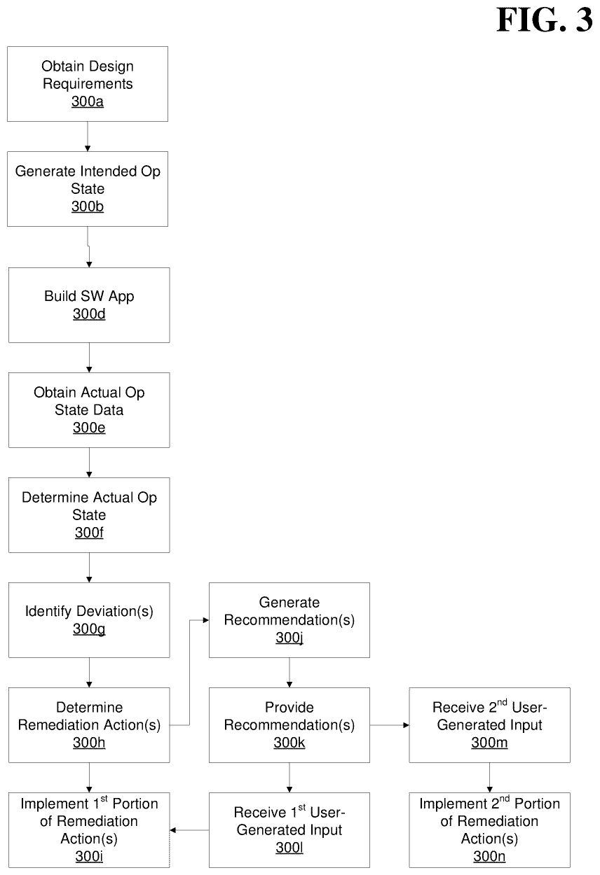

FIG. 3 depicts an illustrative embodiment of a method 300 in accordance with various aspects described herein. Aspects of method 300 may be implemented by aspects of the SLOI system 100a instantiated on one or more servers, described herein. Although the method 300 is directed to the SLOI system 100a analyzing a solution/software application, the steps of method 300 are directed to software application(s) associated with the solution. Persons of ordinary skill in the art would understand that a solution and software application(s) analyzed by the SLOI system 100a are interchangeable or the same. The method 300 may include the SLOI system 100a, at step 300a, obtaining a group of software application design requirements associated with a software application. Further, the method 300 may include the SLOI system 100a, step 300b, generating an intended operational state of the software application based on the group of software application design requirements. In some embodiments, the generating of the intended operational state may be done by utilizing a first knowledge graph. In addition, the method 300 may include the SLOI system 100a, step 300d, building the graph of the software architecture utilizing one of more cloud computing resources. Also, the method 300 may include the SLOI system 100a, step 300e, obtaining actual operational state data associated with the building of the software application from a group of data stores based on the group of software application design requirements. Further, the method 300 may include the SLOI system 100a, step 300f, determining an actual operational state of the software application based on the actual operational state data. In some embodiments, the determining of the actual operational state may be done by utilizing a second knowledge graph. In addition, the method 300 may include the SLOI system 100a, step 300g, identifying a group of deviations from the intended operational state and the actual operation state. This can include detecting gap(s) between the intended operational state and the actual operational state. In some embodiments, the identifying of the group of deviations is performed by utilizing a group of LLMs. Also, the method 300 may include the SLOI system 100a, step 300h, determining a group of remediation actions associated with the group of deviations. In additional embodiments, the determining of the group of remediation actions is performed utilizing the group of LLMs. Also, the determining of the group of remediation actions may be done by utilizing retrieval augmented generation, for example, retrieving context data associated with the software application being analyzed by the SLOI system 100a. Moreover, the determining of the group of remediation actions (as well as generating the intended operational state graph, determining the actual operational state graph, identifying the group of deviations, etc.) may be done by utilizing a group of agents in multi-agent framework. Further, the method 300 may include the SLOI system 100a, step 300i, implementing a first portion of the group of remediation actions on the software application automatically without any user-generated input or human intervention.

In one or more embodiments, method 300 may include the SLOI system 100a, at step 300j, generating a group of recommendations. The group of recommendations indicates the group of remediation actions. Further, the method 300 may include the SLOI system 100a, at step 300k, providing, over a communication network, the group of recommendations to a communication device associated with a user. In addition, the method 300 may include the SLOI system 100a, at step 300l, receiving, over the communication network, first user-generated input from the communication device. The first user-generated input indicates to implement the first portion of the group of remediation actions. In some embodiments, the method 300 may include the SLOI system 100a, at step 300m, receiving, over the communication network, second user-generated input from the communication device. The second user-generated input indicates to implement a second portion of the group of remediation actions. Further, the method 300 may include the SLOI system 100a, at step 300n, implementing the second portion of the group of remediation actions on the software application.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments, one or more blocks may be performed in response to one or more other blocks.

Portions of some embodiments can be combined with portions of other embodiments.

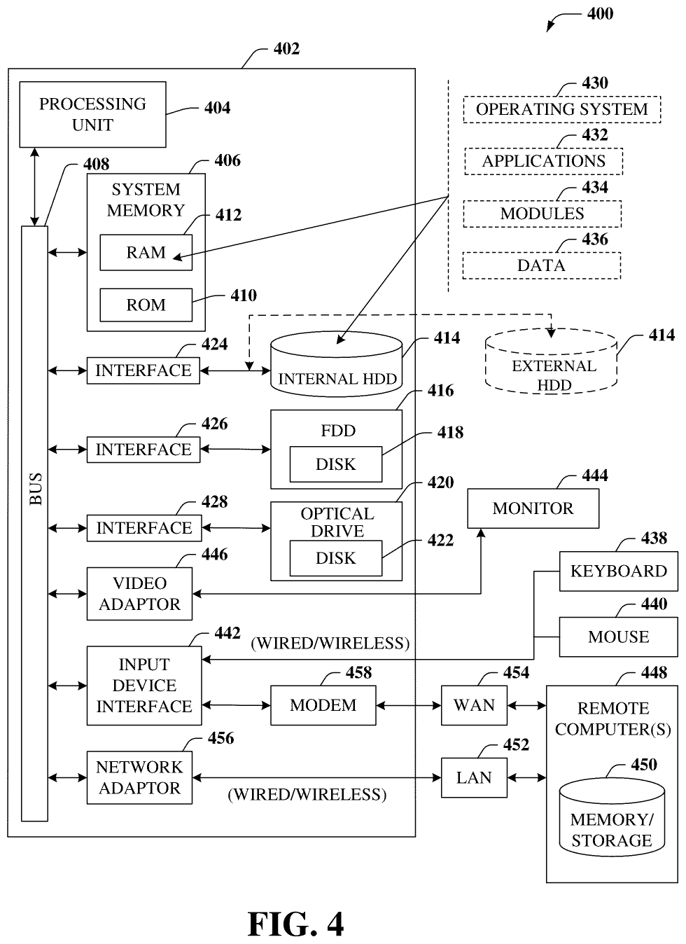

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure may be implemented. For example, aspects of computing environment 400 may facilitate in whole or in part identifying deviations between an intended operation state of a software application and an actual operational state of the software application implemented as a cloud solution, and determining remediation actions for the deviations, accordingly. Each of server 100b, server 100d, servers 100e, and communication device 100g may comprise aspects of computing environment 400.

Generally, program modules comprise routines, programs, components, data structures, etc., that perform particular tasks or implement particular abstract data types. Moreover, those skilled in the art will appreciate that the methods may be practiced with other computer system configurations, comprising single-processor or multiprocessor computer systems, minicomputers, mainframe computers, as well as personal computers, hand-held computing devices, microprocessor-based or programmable consumer electronics, and the like, each of which may be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein may be also practiced in distributed computing environments where certain tasks are performed by remote processing devices that are linked through a communications network. In a distributed computing environment, program modules may be located in both local and remote memory storage devices.

Computing devices typically comprise a variety of media, which may comprise computer-readable storage media and/or communications media, which two terms are used herein differently from one another as follows. Computer-readable storage media may be any available storage media that may be accessed by the computer and comprises both volatile and nonvolatile media, removable and non-removable media. By way of example, and not limitation, computer-readable storage media may be implemented in connection with any method or technology for storage of information such as computer-readable instructions, program modules, structured data or unstructured data.

Computer-readable storage media may comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which may be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media may be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment may comprise a computer 402, the computer 402 comprising a processing unit 404, a system memory 406 and a system bus 408. The system bus 408 couples system components including, but not limited to, the system memory 406 to the processing unit 404. The processing unit 404 may be any of various commercially available processors. Dual microprocessors and other multiprocessor architectures may also be employed as the processing unit 404.

The system bus 408 may be any of several types of bus structure that may further interconnect to a memory bus (with or without a memory controller), a peripheral bus, and a local bus using any of a variety of commercially available bus architectures. The system memory 406 comprises ROM 410 and RAM 412. A basic input/output system (BIOS) may be stored in a non-volatile memory such as ROM, erasable programmable read only memory (EPROM), EEPROM, which BIOS contains the basic routines that help to transfer information between elements within the computer 402, such as during startup. The RAM 412 may also comprise a high-speed RAM such as static RAM for caching data.

The computer 402 further comprises an internal hard disk drive (HDD) 414 (e.g., EIDE, SATA), which internal HDD 414 may also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 may be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, may also be used in the example operating environment, and further, that any such storage media may contain computer-executable instructions for performing the methods described herein.

A number of program modules may be stored in the drives and RAM 412, comprising an operating system 430, one or more application programs 432, other program modules 434 and program data 436. All or portions of the operating system, applications, modules, and/or data may also be cached in the RAM 412. The systems and methods described herein may be implemented utilizing various commercially available operating systems or combinations of operating systems.

A user may enter commands and information into the computer 402 through one or more wired/wireless input devices, e.g., a keyboard 438 and a pointing device, such as a mouse 440. Other input devices (not shown) may comprise a microphone, an infrared (IR) remote control, a joystick, a game pad, a stylus pen, touch screen or the like. These and other input devices are often connected to the processing unit 404 through an input device interface 442 that may be coupled to the system bus 408, but may be connected by other interfaces, such as a parallel port, an IEEE 1394 serial port, a game port, a universal serial bus (USB) port, an IR interface, etc.

A monitor 444 or other type of display device may be also connected to the system bus 408 via an interface, such as a video adapter 446. It will also be appreciated that in alternative embodiments, a monitor 444 may also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 may operate in a networked environment using logical connections via wired and/or wireless communications to one or more remote computers, such as a remote computer(s) 448. The remote computer(s) 448 may be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which may connect to a global communications network, e.g., the Internet.

When used in a LAN networking environment, the computer 402 may be connected to the LAN 452 through a wired and/or wireless communication network interface or adapter 456. The adapter 456 may facilitate wired or wireless communication to the LAN 452, which may also comprise a wireless AP disposed thereon for communicating with the adapter 456.

When used in a WAN networking environment, the computer 402 may comprise a modem 458 or may be connected to a communications server on the WAN 454 or has other means for establishing communications over the WAN 454, such as by way of the Internet. The modem 458, which may be internal or external and a wired or wireless device, may be connected to the system bus 408 via the input device interface 442. In a networked environment, program modules depicted relative to the computer 402 or portions thereof, may be stored in the remote memory/storage device 450. It will be appreciated that the network connections shown are example and other means of establishing a communications link between the computers may be used.

The computer 402 may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This may comprise Wireless Fidelity (Wi-Fi) and BLUETOOTH® wireless technologies. Thus, the communication may be a predefined structure as with a conventional network or simply an ad hoc communication between at least two devices.

Wi-Fi may allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network may be used to connect computers to each other, to the Internet, and to wired networks (which may use IEEE 802.3 or Ethernet). Wi-Fi networks operate in the unlicensed 2.4 and 5 GHz radio bands for example or with products that contain both bands (dual band), so the networks may provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art may recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which may comprise computer-readable storage media and/or communications media, which two terms are used herein differently from one another as follows. Computer-readable storage media may be any available storage media that may be accessed by the computer and comprises both volatile and nonvolatile media, removable and non-removable media. By way of example, and not limitation, computer-readable storage media may be implemented in connection with any method or technology for storage of information such as computer-readable instructions, program modules, structured data or unstructured data. Computer-readable storage media may comprise the widest variety of storage media including tangible and/or non-transitory media which may be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented may optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than may be recognized by the second item. In a further example of indirect coupling, an action in a first item may cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, maybe used in the subject disclosure. For instance, one or more features from one or more embodiments may be combined with one or more features of one or more other embodiments. In one or more embodiments, features that are positively recited may also be negatively recited and excluded from the embodiment with or without replacement by another structural and/or functional feature. The steps or functions described with respect to the embodiments of the subject disclosure may be performed in any order. The steps or functions described with respect to the embodiments of the subject disclosure may be performed alone or in combination with other steps or functions of the subject disclosure, as well as from other embodiments or from other steps that have not been described in the subject disclosure. Further, more than or less than all of the features described with respect to an embodiment may also be utilized.

What is claimed is:

1. A device, comprising:
a processing system including a processor; and
a memory that stores executable instructions that, when executed by the processing system, facilitate performance of operations, the operations comprising:
obtaining a group of software application design requirements associated with a software application;
generating an intended operational state of the software application based on the group of software application design requirements;
building the software application utilizing one of more cloud computing resources based on the group of software application design requirements;
obtaining actual operational state data associated with the building of the software application from a group of data stores;
determining an actual operational state of the software application based on the actual operational state data;
identifying a group of deviations from the intended operational state and the actual operation state;
determining a group of remediation actions associated with the group of deviations; and
implementing a first portion of the group of remediation actions on the software application.

2. The device of claim 1, wherein the operations comprise:
generating a group of recommendations, wherein the group of recommendations indicates the group of remediation actions; and
providing, over a communication network, the group of recommendations to a communication device associated with a user.

3. The device of claim 2, wherein the operations comprise receiving, over the communication network, first user-generated input from the communication device, wherein the first user-generated input indicates to implement the first portion of the group of remediation actions.

4. The device of claim 2, wherein the operations comprise:
receiving, over the communication network, second user-generated input from the communication device, wherein the second user-generated input indicates to implement a second portion of the group of remediation actions; and
implementing the second portion of the group of remediation actions on the software application.

5. The device of claim 1, wherein the identifying of the group of deviations comprises identifying the group of deviations utilizing a group of large language models.

6. The device of claim 5, wherein the determining of the group of remediation actions comprises determining the group of remediation actions utilizing the group of large language models.

7. The device of claim 1, wherein the generating of the intended operational state comprises generating the intended operational state utilizing a first knowledge graph.

8. The device of claim 1, wherein the determining of the actual operational state comprises determining the actual operational state utilizing a second knowledge graph.

9. The device of claim 1, wherein the determining of the group of remediation actions comprises determining the group of remediation actions utilizing retrieval augmented generation.

10. The device of claim 1, wherein the determining of the group of remediation actions comprises determining the group of remediation actions utilizing a group of agents.

11. A non-transitory machine-readable medium, comprising executable instructions that, when executed by a processing system including a processor, facilitate performance of operations, the operations comprising:
obtaining a group of software application design requirements associated with a software application;
generating an intended operational state of the software application based on the group of software application design requirements;
building the software application utilizing one of more cloud computing resources based on the group of software application design requirements;
obtaining actual operational state data associated with the building of the software application from a group of data stores;
determining an actual operational state of the software application based on the actual operational state data;
identifying a group of deviations from the intended operational state and the actual operation state utilizing a group of large language models;
determining a group of remediation actions associated with the group of deviations utilizing the group of large language models; and
implementing a first portion of the group of remediation actions on the software application.

12. The non-transitory machine-readable medium of claim 11, wherein the operations comprise:
generating a group of recommendations, wherein the group of recommendations indicate the group of remediation actions; and
providing, over a communication network, the group of recommendations to a communication device associated with a user.

13. The non-transitory machine-readable medium of claim 12, wherein the operations comprise receiving, over the communication network, first user-generated input from the communication device, wherein the first user-generated input indicates to implement the first portion of the group of remediation actions.

14. The non-transitory machine-readable medium of claim 12, wherein the operations comprise:
receiving, over the communication network, second user-generated input from the communication device, wherein the second user-generated input indicates to implement a second portion of the group of remediation actions; and
implementing a first portion of the group of remediation actions on the software application.

15. The non-transitory machine-readable medium of claim 11, wherein the generating of the intended operational state comprises generating the intended operational state utilizing a first knowledge graph.

16. The non-transitory machine-readable medium of claim 11, wherein the determining of the actual operational state comprises determining the actual operational state utilizing a second knowledge graph.

17. The non-transitory machine-readable medium of claim 11, wherein the determining of the group of remediation actions comprises determining the group of remediation actions utilizing retrieval augmented generation.

18. The non-transitory machine-readable medium of claim 11, wherein the determining of the group of remediation actions comprises determining the group of remediation actions utilizing a group of agents.

19. A method, comprising:
obtaining, by a processing system including a processor, a group of software application design requirements associated with a software application;
generating, by the processing system, an intended operational state of the software application based on the group of software application design requirements;
building, by the processing system, the software application utilizing one of more cloud computing resources based on the group of software application design requirements;
obtaining, by the processing system, actual operational state data associated with the building of the software application from a group of data stores;
determining, by the processing system, an actual operational state of the software application based on the actual operational state data;
identifying, by the processing system, a group of deviations from the intended operational state and the actual operation state;
determining, by the processing system, a group of remediation actions associated with the group of deviations;
implementing, by the processing system, a first portion of the group of remediation actions on the software application;
receiving, by the processing system, over a communication network, user-generated input, wherein the user-generated input indicates to implement a second portion of the group of remediation actions; and
implementing, by the processing system, the second portion of the group of remediation actions on the software application.

20. The method of claim 19, wherein the identifying of the group of deviations comprises identifying the group of deviations utilizing a group of large language models, and wherein the determining of the group of remediation actions comprises determining the group of remediation actions utilizing the group of large language models.
